(19) United States
(12) Patent Application Publication
(10) Pub. No.: US 2024/0261793 A1
(43) Pub. Date: Aug. 8, 2024

(54) Synthetic Turf Recycling

(71) Applicant: Athos Materials, Newport Beach, CA (US)

(72) Inventors: Chris Van Veldhuizen, Ontario, CA (US); David Digeronimo, Valley Center, CA (US); Dustin Parsons, Browns Valley, CA (US)

(21) Appl. No.: 18/165,789

(22) Filed: Feb. 7, 2023

(51) Int. Cl. B03B 9/06; B09B 3/35

(52) U.S. Cl. CPC B03B 9/06; B09B 3/35

(57) ABSTRACT

Approaches for recycling used artificial turf are disclosed. A low-speed shredder is used to generate ground material from a roll of artificial turf. A set of one or more screens are configured to receive the ground material from the low-speed shredder. The set of one or more screens separate, from the ground material, artificial turf fibers and infill material. A sand screw machine is configured to receive the infill material from the screens. The sand screw machine to utilize rising water current to separate lighter-weight infill material from heavier-weight infill material. A density separator is configured to receive the heavier-weight infill material from the sand screw machine and to further separate the heavier-weight infill material.

### BACKGROUND

Artificial turf (also referred to as “synthetic turf” or “astroturf”) is a replacement for natural grass that includes synthetic fibers made to look like natural grass blades. Artificial turf is increasingly used in sports arenas for sports traditionally played on grass surfaces, for example, football, lacrosse, soccer, field hockey, baseball, softball, golf, etc. Artificial turf can also be utilized in commercial and residential landscaping. Thus, millions of square feet of artificial turf is deployed annually.

Unfortunately, artificial turf has a limited useful life after which it should be replaced. The life span of artificial turf varies significantly, but is often approximately 15 years depending on usage, type of infill (e.g., sand, rubber, cork), environmental factors (e.g., hours of sunlight, temperature, maintenance), initial quality, etc. With increasing numbers of artificial turf applications combined with limited life spans, large amounts of used artificial turf is removed and replaced each year. Disposal of used artificial turf can be expensive and complicated due to, for example, weight and size factors as well as environmental concerns.

### BRIEF SUMMARY

In an example method, a roll of artificial turf is processed with a low-speed shredder to generate ground material. The ground material is screened to separate artificial turf fibers and infill material. The infill material is processed with a sand screw processor to separate lighter-weight infill material from heavier-weight infill material. The heavier-weight infill material is processed with a density separator to further separate the heavier-weight infill material.

In a further example method, the roll of artificial turf includes synthetic turf fibers connected to a backing material and infill material. In another example method, the lighter-weight infill material is dewatered and/or stored. In another example method, processing the infill material with a sand screw processor to separate lighter-weight infill material from heavier-weight infill material is based on utilizing rising water current to separate the lighter-weight infill material from the heavier-weight infill material.

In a further example method, the density separator utilizes a rising current to further separate the heavier-weight infill material. In another example method, the lighter-weight infill material is transferred over water weirs in the sand screw machine as part of a water slurry. In another example method, the low-speed shredder operates at less than 50 revolutions per minute.

An example system includes a low-speed shredder to generate ground material from a roll of artificial turf, a set of one or more screens to receive the ground material from the low-speed shredder and to separate artificial turf fibers from infill material, a sand screw machine to receive the infill material from the screens, the sand screw machine to utilize rising water current to separate lighter-weight infill material from heavier-weight infill material, and a density separator to receive the heavier-weight infill material from the sand screw machine, the density separator to further separate the heavier-weight infill material.

In a further system example, the roll of artificial turf includes synthetic turf fibers connected to a backing material and infill material. In another system example, one or more storage containers are configured to store one or more of the artificial turf fibers, the infill material, the lighter-weight infill material, and the heavier-weight infill material. In another system example, dewatering machinery is utilized to dewater one or more of the lighter-weight infill material and the heavier-weight infill material.

In a further system example, the density separator utilizes a rising current to further separate the heavier-weight infill material. In another system example, the low-speed shredder operates at less than 50 revolutions per minute.

In an example non-transitory computer-readable having stored thereon instructions that, when executed by one or more processors, cause a system to process a roll of artificial turf with a shredder to generate ground material, to screen the ground material to separate artificial turf fibers and infill material, to process the infill material with a sand screw processor to separate lighter-weight infill material from heavier-weight infill material, and to process the heavier-weight infill material with a density separator to further separate the heavier-weight infill material.

In a further example, the instructions cause the system to operate the shredder at less than 50 revolutions per minute. In another example, the instructions cause the system to process the infill material with a sand screw processor to separate lighter-weight infill material from heavier-weight infill material comprises utilizing rising water current to separate the lighter-weight infill material from the heavier-weight infill material.

In another example, the instructions cause the system to transfer the lighter-weight infill material over water weirs in the sand screw machine as part of a water slurry. In another example, the instructions cause the system to dewater the lighter-weight infill material. In another example, the instructions cause the system to operate the density separator utilizing a rising current to further separate the heavier-weight infill material.

### BRIEF DESCRIPTION OF THE DRAWINGS

The various advantages and features of the technology being described will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 conceptually illustrates example artificial turf recycling.

FIG. 2 is a flow diagram corresponding to an example technique for recycling artificial turf.

FIG. 3 is a block diagram of a computing platform within which a set of instructions, for causing the machine to perform any one or more of the methodologies discussed herein, may be executed.

FIG. 4 is a block diagram of an example processing system that can support recycling of artificial turf.

### DETAILED DESCRIPTION

As discussed above, large quantities of used artificial turf are removed and must be disposed of each year. Disposing of the used artificial turf in landfills is wasteful. Various approaches for recycling used artificial turf are described herein. These approaches can provide more efficient and economical disposition of used artificial turf that has been available. Specifically, improved recovery techniques are provided that allow for a higher percentage of reused materials than can be achieved by current processes.

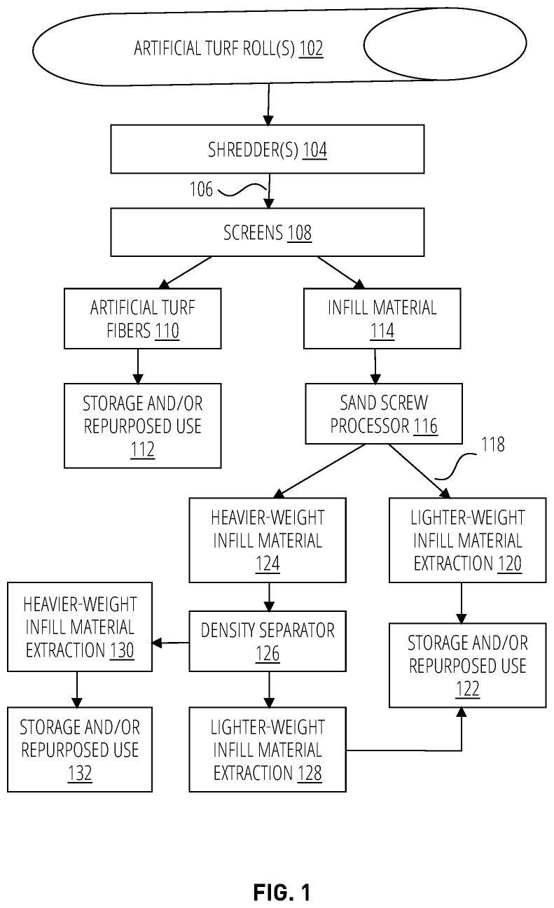

FIG. 1 conceptually illustrates example artificial turf recycling. Artificial turf roll(s) 102 are fed into shredder(s) 104. Used artificial turf is typically removed in large strips that are transported as large rolls to be processed and/or disposed. Other formats of used artificial turf can be processed in the manner described herein. For example, squares of used artificial turf can be processed, or irregular-shaped pieces of artificial turf can be processed.

Shredder(s) 104 can be a large machine for shredding wood and/or waste products. In an example, shredder(s) 104 can include two slow-rotating (e.g., less than 40 revolutions per minute (RPM), less than 50 RPM, less than 55 RPM) drums with shredding tools (or “teeth”) to shred materials provided to shredder(s) 104. As an example, shredder(s) 104 can be a Komptech Crambo 6000 shredder utilizing bio teeth. The Crambo 6000 shredder is available from Komptech GmbH of Grohnleiten, Steiermark, Austria. Other shredders having similar capabilities can also be utilized.

Bio countercut teeth that can be used with the Crambo 6000 shredder include, for example, KFM094 and KFS1196 made from wear-resistant steel available from King Kong Tools LLC of Buford, GA. Other shredder teeth can also be used. The shredding generates ground material 106 that includes both artificial turf fibers, artificial turf fiber backing, infill material and/or other materials.

Ground material 106 is processed by screens 108 (which can be part of shredder(s) 104 or separate components) to separate artificial turf fibers 110 from infill material 114. In an example, shredder(s) 104 utilize a bottom screen that is a diamond 2-inch pattern and ground material 106 that passes through the bottom screen of shredder(s) 104 is processed by screens 108, which can be, in an example, a 0.5-inch top screen and a #10 mesh bottom screen, which can be used to separate artificial turf fibers 110 from infill material 114. In other examples, different screen configurations can be utilized, for example, a 0.45-inch top screen, 0.65-in top screen, #12 mesh bottom screen, #14 mesh bottom screen can be utilized.

After separation, artificial turf fibers 110 can be placed in storage and/or repurposed use 112. In an example, after separation, infill material 114 is transferred to sand screw processor 116 that utilizes rising water current to separate lighter-weight infill material 118 from heavier-weight infill material 124. Within sand screw processor 116, lighter-weight infill material travels over water weirs on the sand screw in a water slurry.

In an example, lighter-weight infill material extraction 120 can be performed by dewatering the slurry carrying the lighter-weight infill material. The extracted lighter-weight infill material can be placed in storage and/or repurposed use 122.

In an example, heavier-weight infill material 124 is transferred to density separator 126 that further separates heavier-weight infill material 124. In an example, heavier-weight infill material 124 is separated into two sizes, for example, a medium-weight infill material and a heavier-weight infill material. In another example, heavier-weight infill material 124 is separated according to approximately the same parameters as sand screw processor 116 in order to provide a more through separation between the lighter-weight infill material and the heavier-weight infill material.

From the output of density separator 126, heavier-weight infill material extraction 130 is performed and the heavier-weight infill material can be placed in storage and/or repurposed use 132. Similarly, lighter-weight infill material extraction 128 is performed and the lighter-weight infill material can be placed in storage and/or repurposed use 122.

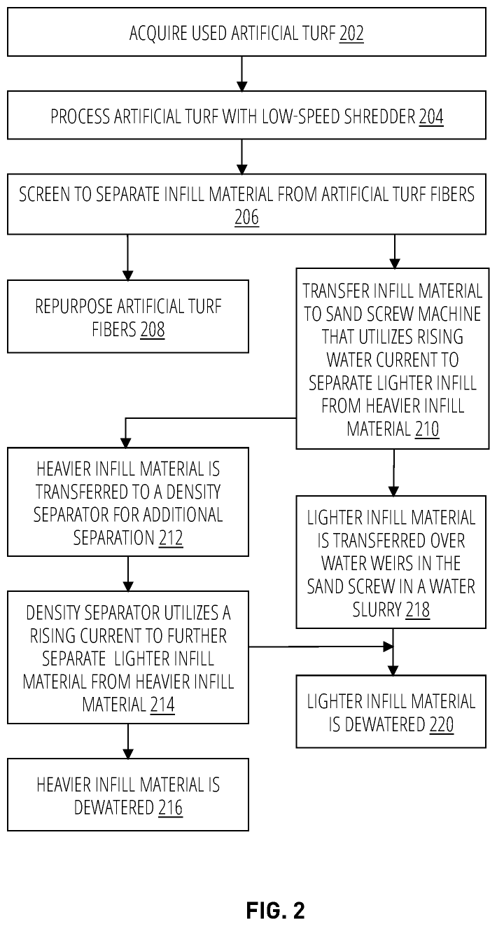

FIG. 2 is a flow diagram corresponding to an example technique for recycling artificial turf. Artificial turf to be recycled is acquired, 202. As discussed above, used artificial turf is typically removed in large strips that are transported as large rolls; however, other formats of used artificial turf can be processed in the manner described herein. For example, squares of used artificial turf can be processed, or irregular-shaped pieces of artificial turf can be processed.

The artificial turf to be recycled is processed with a low-speed shredder, 204. In an example, the low-speed shredder includes two slow-rotating (e.g., less than 30 revolutions per minute (RPM), less than 40 RPM, less than 45 RPM) drums with shredding teeth selected to effectively shred the used artificial turf.

A rough screening procedure is applied to the ground material from the shredder to separate infill material from artificial turf fibers, 206. In an example, a first screening is performed by a screen that is a diamond 2-inch pattern and further screening can be accomplished using, a 0.5-inch top screen and a #10 mesh bottom screen, which can be used to separate artificial turf fibers from infill material. In other examples, different screen configurations can be utilized, for example, a 0.45-inch top screen, 0.65-in top screen, #12 mesh bottom screen, #14 mesh bottom screen can be utilized.

The artificial turf fibers that have been separated from the infill material can then be repurposed, 208. In another example, the recovered artificial turf fibers can be stored for later usage and/or disposed of in some way.

The infill material that has been separated from artificial turf fibers is transferred to a sand screw machine that utilizes rising water current to separate lighter-weight infill material from heavier-weight infill material, 210. The lighter-weight infill material is transferred over water weirs in the sand screw machine in a water slurry, 218. The lighter-weight infill material can then be dewatered, 220, and stored or repurposed.

The heavier-weight infill material is transferred to a density separator for additional separation, 212. The density separator utilizes a rising current to further separate lighter-weight infill material from heavier-weight infill material, 214. The lighter-weight infill material from the density separator is dewatered, 220, and stored or repurposed. Similarly, the heavier-weight infill material from the density separator is dewatered, 216, and stored or repurposed.

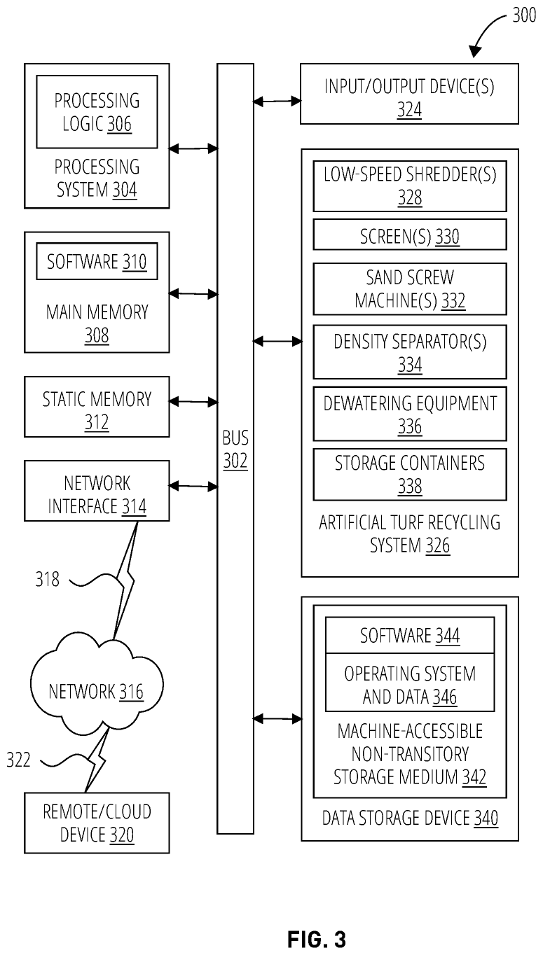

FIG. 3 is a block diagram of a computing platform within which a set of instructions, for causing the machine to perform any one or more of the methodologies discussed herein, may be executed. In an example, computing platform 300 is a programmable logic controller (PLC) based system in which one or more PLCs are used to control one or more of the various electro-mechanical processes described herein. In alternate examples, computing platform 300 may be connected (e.g., networked) to other machines in a LAN, an intranet, an extranet, the Internet, the Internet of Things (IoT), etc.

Computing platform 300 may operate in the capacity of a server or a client machine in a client-server network environment, or as a peer machine in a peer-to-peer (or distributed) network environment. In an example, some or all of computing platform 300 can include PLC-based systems/components. Other, non-PLC-based components of computing platform 300 can utilize (or be based on) a personal computer (PC), a tablet PC, a cellular telephone, a mobile device, a web appliance, a server, a network router, switch or bridge, or any machine capable of executing a set of instructions (sequential or otherwise) that specify actions to be taken by the host computing platform. Further, while only a single computing platform is illustrated, the label “computing platform” shall also be taken to include any collection of machines that individually or jointly execute a set (or multiple sets) of instructions to perform any one or more of the methodologies discussed herein.

In an example, computing platform 300 includes processing system 304, main memory 308 (e.g., read-only memory (ROM), flash memory, dynamic random access memory (DRAM) such as synchronous DRAM (SDRAM) or Rambus DRAM (RDRAM), etc.), static memory 312 (e.g., flash memory, static random access memory (SRAM), etc.), and data storage device 340, which communicate with each other via bus 302.

Computing platform 300 is configured to execute instructions to perform artificial turf recycling operations as described herein. For example, computing platform 300 can control the operation one or more of the techniques and approaches described herein through execution of software 310 and/or software 344.

Computing platform 300 can be configured to collect data and to transmit data to a remote location such as remote/cloud device 320 that is connected to network 316. Network interface 314 transmits data to, and receives data from, network 316 via network connection(s) 318. Similarly, remote/cloud device 320 transmits data to, and receives data from, network 316 via network connection(s) 322. Data collected by computing platform 300 can be stored in data storage device 340 and also in a remote location such as remote/cloud device 320 for retrieval, archival and/or further processing.

Processing system 304 represents one or more processing devices such as a microprocessor, central processing unit, PLC, or the like. More particularly, processing system 304 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing system 304 may also be one or more special-purpose processing devices such as an application specific integrated circuit (ASIC), a field programmable gate array (FPGA), a digital signal processor (DSP), network processor, or the like. Processing system 304 is configured (at least) to execute processing logic 306 for performing the operations and techniques discussed herein. Processing system 304 may include one or more of a signal processor, artificial intelligence (AI) module, etc. (not specifically illustrated in FIG. 3). Computing platform 300 may further include input/output device(s) 324 or display (e.g., a liquid crystal display (LCD), a plasma display, a cathode ray tube (CRT), or touch screen for receiving user input and displaying output.

Data storage device 340 may include machine-accessible non-transitory storage medium 342 on which is stored one or more sets of instructions (e.g., software 344) embodying any one or more of the methodologies or functions described herein. Machine-accessible non-transitory storage medium 342 may further include operating system and data 346, which can be used to control the operation of computing platform 300. Software 344 may also reside, completely or at least partially, within main memory 308 (e.g., software 310) and/or within processing system 304 during execution thereof by computing platform 300, main memory 308 and processing system 304 also constituting machine-accessible storage media. Software 310 or software 344 may further be transmitted or received over network 316 via network interface 314 utilizing, for example, network connection(s) 318.

Machine-accessible non-transitory storage medium 342 may also be used to store data (as part of operating system and data 346) corresponding to measurements and analysis to be utilized with respect to control and operation of artificial turf recycling system 326. Data may also be stored in other sections of computing platform 300, such as static memory 312, main memory 308, or remote/cloud device 320.

In an example, processing system 304, by executing software 310 and/or software 344, can cause low-speed shredder(s) 328 to shred one or more turf rolls (with or without infill). In an example, low speed refers to less than 40 revolutions per minute (RPM). In other examples, different low-speed thresholds (e.g., 50 RPM, 55 RPM, 45 RPM, 60 RPM) can be utilized. In an example, low-speed shredder(s) 328 can utilize both forward and reversing shafts and can utilize a bio tooth for grinding. In an example, a bottom screen in low-speed shredder(s) 328 is a diamond 2-inch screen. In other examples, different screen sizes (e.g., 2.25-inch, 1.8-inch, 1.75-inch, 2.1-inch) can be utilized.

Ground material from low-speed shredder(s) 328 is transferred to screen(s) 330 to separate infill material from artificial turf material (e.g., synthetic grass fibers). In an example, screen(s) 330 include a 0.5-inch top screen and a #10 mesh bottom screen. In alternate examples, different screen configurations (e.g., 0.4-inch top screen, 0.55-in top screen, #8 mesh bottom screen, #12 mesh bottom screen) can be utilized.

The infill material can be transferred to sand screw machine(s) 332 that utilizes rising water current to separate lighter weight infill materials (e.g., crumb rubber) from heavier weight infill materials (e.g., sand). The lighter weight infill materials go over the water weirs of sand screw machine(s) 332 in a water slurry. The lighter weight infill materials are then dewatered with dewatering equipment 336 and stored in storage containers 338.

In an example, the heavier infill materials are transferred to density separator(s) 334 for additional separation. Density separator(s) 334 utilize a rising current to further remove lighter weight infill materials from the heavier weight infill materials. The lighter weight infill materials removed by density separator(s) 334 are then dewatered with dewatering equipment 336 and stored in storage containers 338. The heavier weight infill materials are dewatered with dewatering equipment 336 and stored in storage containers 338. Any number of storage containers can be provided to support the desired level of separation between infill material types/weights.

In an example, data storage device 340 contains machine-accessible non-transitory storage medium 342, which stores and provides executable computer program instructions (e.g., software 344) that, when executed by processing system 304, cause computing platform 300 to perform any of the operations discussed herein to control operation of artificial turf recycling system 326 including one or more of low-speed shredder(s) 328, screen(s) 330, sand screw machine(s) 332, density separator(s) 334, dewatering equipment 336, and/or storage containers 338.

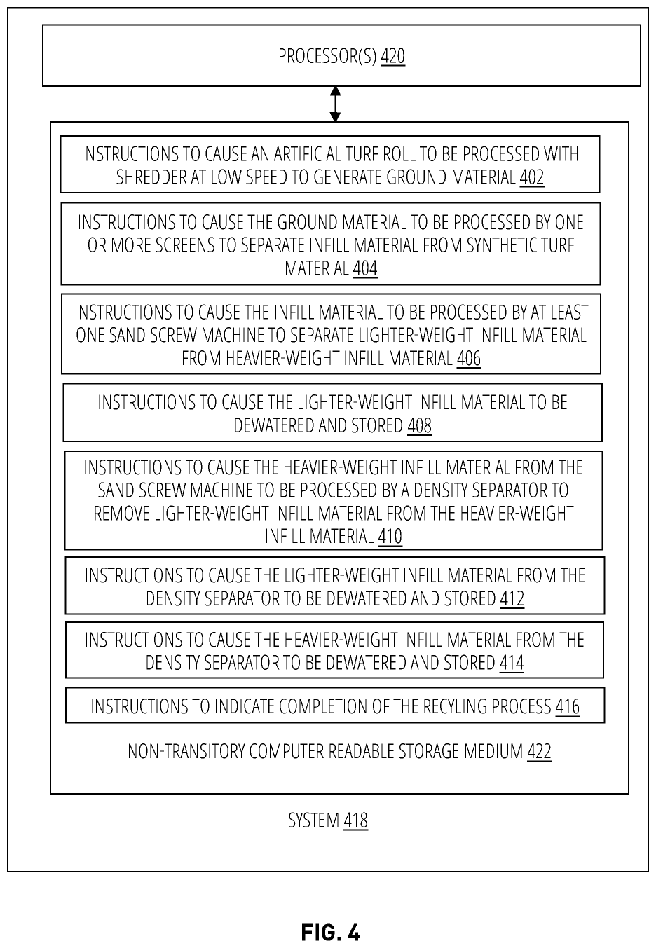

FIG. 4 is a block diagram of an example processing system that can support recycling of artificial turf. In an example, the processing system of FIG. 4 can be part of computing platform 300 as illustrated in FIG. 3.

In an example, system 418 can include processor(s) 420 and non-transitory computer readable storage medium 422. Non-transitory computer readable storage medium 422 may store instructions 402, 404, 406, 408, 410, 412, 414 and 416 that, when executed by processor(s) 420, cause processor(s) 420 to perform various functions. Examples of processor(s) 420 may include a microcontroller, a PLC, a microprocessor, a central processing unit (CPU), a graphics processing unit (GPU), a data processing unit (DPU), an application-specific integrated circuit (ASIC), an field programmable gate array (FPGA), a system on a chip (SoC), etc. Examples of a non-transitory computer readable storage medium 422 include tangible media such as random access memory (RAM), read-only memory (ROM), electrically erasable programmable read-only memory (EEPROM), flash memory, a hard disk drive, etc.

Instructions 402 cause processor(s) 420 to cause a roll of artificial turf to be processed with a shredder at a low speed to generate ground material. In an example, low speed refers to less than 40 revolutions per minute (RPM). In other examples, different low-speed thresholds (e.g., 50 RPM, 55 RPM, 45 RPM, 35 RPM) can be utilized. In an example, the shredder and utilize both forward and reversing shafts and can utilize a bio tooth for grinding.

Instructions 404 cause processor(s) 420 to cause the ground material to be processed by one or more screens to separate infill material from synthetic turf material. In an example, the screens include a 0.5-inch top screen and a #10 mesh bottom screen. In alternate examples, different screen configurations (e.g., 0.4-inch top screen, 0.55-in top screen, #8 mesh bottom screen, #12 mesh bottom screen) can be utilized.

Instructions 406 cause processor(s) 420 to cause the infill material to be processed by a sand screw machine to separate lighter-weight infill material from heavier-weight infill material. The sand screw machine that utilizes rising water current to separate lighter weight infill materials (e.g., crumb rubber) from heavier weight infill materials (e.g., sand). The lighter-weight infill materials go over the water weirs of sand screw machine in a water slurry.

Instructions 408 cause processor(s) 420 to cause the lighter-weight infill material from the sand screw machine to be dewatered. The recovered lighter-weight infill material can then be stored, repurposed, sold, transported, etc.

Instructions 410 cause processor(s) 420 to cause the heavier-weight infill material from the sand screw machine to be processed by a density separator to further separate the heavier-weight infill material by removing remaining lighter-weight infill material from the heavier-weight infill material. In an example, the heavier-weight infill material is separated into two sizes, for example, a medium-weight infill material and a heavier-weight infill material. In another example, the heavier-weight infill material is separated according to approximately the same parameters as the sand screw processor (e.g., in block 406) in order to provide a more through separation between the lighter-weight infill material and the heavier-weight infill material.

Instructions 412 cause processor(s) 420 to cause the lighter-weight infill material from the density separator to be dewatered. The recovered lighter-weight infill material can then be stored, repurposed, sold, transported, etc.

Instructions 414 cause processor(s) 420 to cause the heavier-weight infill material from the density separator to be dewatered. The recovered lighter-weight infill material can then be stored, repurposed, sold, transported, etc.

Instructions 416 cause processor(s) 420 to generate and/or transmit and indication of completion of the recycling process. The indication can be, for example, a visual indicator (e.g., light) on computing platform 300 of FIG. 3 and/or a visual indicator on one or more of the components of the recycling process. An electronic message (e.g., email, text message, LED sign) can also be used to indicate completion of the recycling process.

In the description above, for the purposes of explanation, numerous specific details are set forth in order to provide a thorough understanding of the described examples. It will be apparent, however, to one skilled in the art that examples may be practiced without some of these specific details. In other instances, well-known structures and devices are shown in block diagram form. There may be intermediate structures between illustrated components. The components described or illustrated herein may have additional inputs or outputs that are not illustrated or described.

Various examples may include various processes. These processes may be performed by hardware components or may be embodied in computer program or machine-executable instructions, which may be used to cause processor or logic circuits programmed with the instructions to perform the processes. Alternatively, the processes may be performed by a combination of hardware and software.

Portions of various examples may be provided as a computer program product, which may include a non-transitory computer-readable medium having stored thereon computer program instructions, which may be used to program a computer (or other electronic devices) for execution by one or more processors to perform a process according to certain examples. The computer-readable medium may include, but is not limited to, magnetic disks, optical disks, read-only memory (ROM), random access memory (RAM), erasable programmable read-only memory (EPROM), electrically erasable programmable read-only memory (EEPROM), magnetic or optical cards, flash memory, or other type of computer-readable medium suitable for storing electronic instructions.

Moreover, examples may also be downloaded as a computer program product, wherein the program may be transferred from a remote computer to a requesting computer. In some examples, non-transitory computer readable storage media (e.g., non-transitory computer readable storage medium 422) have stored thereon data representing sequences of instructions that, when executed by one or more processors (e.g., processor(s) 420), cause the one or more processors to perform certain operations.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Reference in the specification to “an example,” “one example,” “some examples,” or “other examples” means that a particular feature, structure, or characteristic described in connection with the examples is included in at least some examples, but not necessarily all examples. Additionally, such feature, structure, or characteristics described in connection with “an example,” “one example,” “some examples,” or “other examples” should not be construed to be limited or restricted to those example(s), but may be, for example, combined with other examples. The various appearances of “an example,” “one example,” or “some examples” are not necessarily all referring to the same examples.

What is claimed is:

1. A method comprising:
processing a roll of artificial turf with a low-speed shredder to generate ground material;
screening the ground material to separate artificial turf fibers and infill material;
processing the infill material with a sand screw processor to separate lighter-weight infill material from heavier-weight infill material;
processing the heavier-weight infill material with a density separator to further separate the heavier-weight infill material.

2. The method of claim 1 wherein the roll of artificial turf comprises synthetic turf fibers connected to a backing material and infill material.

3. The method of claim 1 wherein processing the infill material with a sand screw processor to separate lighter-weight infill material from heavier-weight infill material comprises utilizing rising water current to separate the lighter-weight infill material from the heavier-weight infill material.

4. The method of claim 3 further comprising dewatering the lighter-weight infill material.

5. The method of claim 1 wherein the density separator utilizes a rising current to further separate the heavier-weight infill material.

6. The method of claim 1 further comprising dewatering the heavier-weight infill material.

7. The method of claim 1 wherein the low-speed shredder operates at less than 50 revolutions per minute.

8. A system for recycling used artificial turf, the system comprising:
a low-speed shredder to generate ground material from a roll of artificial turf;
a set of one or more screens configured to receive the ground material from the low-speed shredder, the set of one or more screens to separate, from the ground material, artificial turf fibers and infill material;
a sand screw machine configured to receive the infill material from the one or more screens, the sand screw machine to utilize rising water current to separate lighter-weight infill material from heavier-weight infill material;
a density separator configured to receive the heavier-weight infill material from the sand screw machine, the density separator to further separate the heavier-weight infill material.

9. The system of claim 8 wherein the roll of artificial turf comprises synthetic turf fibers connected to a backing material and infill material.

10. The system of claim 8 further comprising one or more storage containers configured to store one or more of the artificial turf fibers, the infill material, the lighter-weight infill material, and the heavier-weight infill material.

11. The system of claim 8 further comprising dewatering machinery to dewater one or more of the lighter-weight infill material and the heavier-weight infill material.

12. The system of claim 8 wherein the lighter-weight infill material is transferred over water weirs in the sand screw machine as part of a water slurry.

13. The system of claim 8 wherein the density separator utilizes a rising current to further separate the heavier-weight infill material.

14. The system of claim 8 wherein the low-speed shredder operates at less than 50 revolutions per minute.

15. A non-transitory computer-readable having stored thereon instructions that, when executed by one or more processors, cause a system to:
process a roll of artificial turf with a shredder to generate ground material;
screen the ground material to separate artificial turf fibers and infill material;
process the infill material with a sand screw processor to separate lighter-weight infill material from heavier-weight infill material;
process the heavier-weight infill material with a density separator to further separate the heavier-weight infill material.

16. The non-transitory computer-readable of claim 15 wherein the shredder operates at less than 50 revolutions per minute.

17. The non-transitory computer-readable of claim 15 wherein processing the infill material with a sand screw processor to separate lighter-weight infill material from heavier-weight infill material comprises utilizing rising water current to separate the lighter-weight infill material from the heavier-weight infill material.

18. The non-transitory computer-readable of claim 17 wherein the lighter-weight infill material is transferred over water weirs in the sand screw machine as part of a water slurry.

19. The non-transitory computer-readable of claim 18 further comprising dewatering the lighter-weight infill material.

20. The non-transitory computer-readable of claim 15 wherein the density separator utilizes a rising current to further separate the heavier-weight infill material.
